(19) United States
(12) Patent Application Publication
(10) Pub. No.: US 2007/0109762 A1
(43) Pub. Date: May 17, 2007

(54) Method for optimizing a vehicle light and corresponding headlight device

(75) Inventors: Jan Boehm, Magstadt (DE); Volker Reinhold, Herrenberg (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STITTGART (DE)

(21) Appl. No.: 10/571,428

(22) PCT Filed: Aug. 18, 2004
(86) PCT No.: PCT/EP04/09233

§ 371 Date: Dec. 13, 2006

(30) Foreign Application Priority Data
Sep. 17, 2003 (DE) 103 42 927.1

(51) Int. Cl. B60Q 1/00

(52) U.S. Cl. 362/37

(57) ABSTRACT

The invention relates to a method for optimizing a vehicle light and to a headlight device for executing the method, light having a light distribution with a greater horizontal scattering range than that of the passing light being generated, a fog light distribution being impressed on the passing light distribution as a function of a steering angle in accordance with a switch-on characteristic.

It is provided according to the invention that in accordance with prescribed switch-on characteristics an additional luminaire 5 is switched in as a turning light below a maximum speed of V_{maxFRA}, and as a static cornering light below a maximum speed vₘₐₓ that is higher than v_{maxFRA}, and is switched off in accordance with prescribed switch-off characteristics.

### BACKGROUND AND SUMMARY OF THE INVENTION

This invention relates to a method for optimizing a vehicle light, and to a headlight device.

German document DE 197 19 573 A1 discloses a static cornering light, the cornering being detected via a steering lock sensor or yaw angle sensor, and if the speed of the vehicle is below 60 km/h, the front fog light on the inside of the corner is switched on as a cornering or turning light. The cornering light is preferably coupled to the passing light and/or upper beam of the motor vehicle such that the turning light is switched in on only when the main luminaires have been switched on.

European document EP 0 832 785 B1 discloses a method for adapting a vehicle light during cornering, a cornering light having a light distribution with a greater horizontal scattering range than that of the passing light being generated, a fog light distribution of a fog light being impressed on a passing light with a passing light distribution as a function of the cornering in a fashion regulated by brightness. The cornering light need not be generated by a single reflector of the headlight unit, but two reflectors, specifically a passing light reflector of a first headlight, and a fog light reflector of a second headlight.

Japanese publication JP 60099737 A1 discloses a cornering light that is switched on when a turn indicator signal is activated. Upon activation of the left-hand turn indicator, a cornering light is activated on the left-hand side. The cornering light is deactivated automatically again after a specific time after deactivation of the turn indicator.

German document DE 101 04 773 A1 discloses a lighting system for vehicles that has a number of turning luminaires that are switched on as a function of the steering angle. The larger the steering angle becomes, the more turning luminaires are switched in. Various steering angles are provided for this purpose, and the turning luminaires are switched in when these steering angles are detected. In addition, at relatively high vehicle speeds, the number of turning luminaires that are switched on is reduced in order to reduce the lighting range.

German document DE 101 39 150 A1 describes a vehicle headlight system having a headlight with reflectors that can be tilted on both sides, and with an additional turning luminaire. A bend lying ahead is determined by means of route guidance, and the arrival time of the vehicle is calculated. Thereupon, the reflector of the headlight is tilted as a function of the steering-angle sensor and of the speed of the vehicle. When a turn indicator has been set, it is necessary to drop below a limiting turning speed V_{c} in order to switch on the turning light.

A cornering light for a vehicle is described in U.S. Pat. No. 5,526,242, in the case of which the angle of the cornering light is set as a function of the current steering angle and of the speed of the vehicle. The cornering light becomes the turning light when the turn indicator is set. With the right-hand turn indicator set, the right-hand turning light is switched on with the maximum angle of the cornering light. The activation of the left-hand turning light follows similarly with the left-hand turn indicator set.

U.S. Pat. No. 5,754,100 discloses an assistance system for supporting reverse cornering. During the reverse cornering, the left-hand and right-hand headlights are aligned as a function of the front wheel steering angle.

Japanese publication JP 2002225623 discloses a cornering light whose light is dimmed up at a prescribed time and is dimmed down at a further prescribed time.

One disadvantage in a known system is that the system is always set very sensitively such that, with each change in steering-wheel angle, a change occurs in the static cornering light or turning light. The additional light distribution comes on in this case with every mini bend, or else prematurely, and with every small change in steering-wheel angle. However, the system can also be set insensitively. Switching on then always occurs relatively late. Both types of switching on, whether sensitive or insensitive, are not optimum for illuminating the bend or turn-off, and are a cause of confusion to the driver owing to rapid and frequent change.

It is therefore one object of the invention to improve a vehicle light as static cornering light or turning light such that an opening into a street is illuminated optimally in good time without causing the driver irritation.

This object is achieved according to the invention, and advantageous refinements and developments of the subject matter of the invention are claimed.

A substantial advantage of these refinements is that an opening into a street is illuminated even before the actual turning operation with the aid of the turning light according to the invention. Precisely in the case of streets with low levels of illumination, it is greatly advantageous when the opening into the turning street can already be seen and assessed in advance. The driver has no need to strongly curb his normal speed in order not to miss the opening or exit. However, he must drop below the maximum speed of usually 60 km/h so that the static cornering light is activated. However, this is usually the case when the driver intends to drive along a bend. Given the same steering angle, in the case of an activated flasher the switch-on characteristic for the turning light is lowered by a desired value such that, given the same steering angle, the static cornering light is activated earlier with an activated flasher than with a non-activated flasher. The system reacts more sensitively in the case of an activated flasher. Given an activated flasher, the static cornering light is already activated given a small steering lock.

The present invention is explained in more detail with the aid of an exemplary embodiment in conjunction with a description of the drawing figures.

### BRIEF DESCRIPTION OF THE DRAWINGS

FIG. 1 shows a schematic of a headlight device with the arrangement of the cornering light function or turning light function;

FIG. 2 shows graphs relating to the activation of the turning light;

FIG. 3 shows graphs relating to the activation and deactivation of the additional light in the case of a combination of static cornering light and turning light; and

FIG. 4 shows a graph relating to the activation and deactivation of the static cornering light.

### DETAILED DESCRIPTION OF THE INVENTION

FIG. 1 shows a schematic of a headlight device with the arrangement of the cornering light function or turning light function. In the main headlight 1 in the left-hand illustration are various light functions such as the passing light 2, the upper beam 3, the turn indicator 4 and the additional light 5 which is arranged as turning light and/or static cornering light. Moreover, a front fog light 6 is arranged separately from the main headlight 1. This front fog light 6 is usually arranged in or on the fender 7 and is switched to be active by the driver in the event of fog.

In the right-hand illustration, the turning light 5 is arranged separately from the main headlight 1 and separately from the front fog light 6, but next to the front fog light 6 in the fender 7. However, the additional light 5 could also be integrated into the front fog light 6. This arrangement is not illustrated here. It will also be possible in this case for the front fog light 6 to serve directly as additional luminaire 5 that can then be activated by the driver as usual as a front fog light 6, or else be switched in as a turning light and/or static cornering light 5 in accordance with the switch-on conditions. However, it is also possible to integrate an independent light source or else an independent light source with a dedicated reflector as additional luminaire 5 in the front fog light 6. The turning light and/or static cornering light has a dedicated light distribution. This light distribution is impressed on the passing light distribution as turning light and/or static cornering light. The customary passing light headlight 1 is provided with a passing light distribution. Moreover, provision is made of an additional light 5 with a horizontally wider light distribution, the distribution of the cornering light or turning light being switched into the passing light distribution in order to activate the cornering light and/or turning light. The turning light is a static cornering light in this case, since the headlight is not also moved along the bend, but the new light distribution is implemented only solely by the impressing of the additional luminaire. The front fog lights exhibit a right-hand and left-hand front fog light, only the left-hand additional luminaire being activated in the event of a left steering lock, while only the right-hand additional luminaire is activated in the event of a right steering lock. Instead of the steering lock sensor, it is also possible to provide more suitable sensors that absorb the forces acting on the vehicle in the bend, in particular an angular speed sensor, a centrifugal force sensor and/or a yaw angle sensor. The additional headlight 5 itself does not move, but instead only the cornering light and/or turning light is impressed, a static cornering light being implemented at a maximum speed of usually 70 km/h (which can be established between 60 and 80 km/h), or else a turning light is implemented at a maximum speed of 40 km/h.

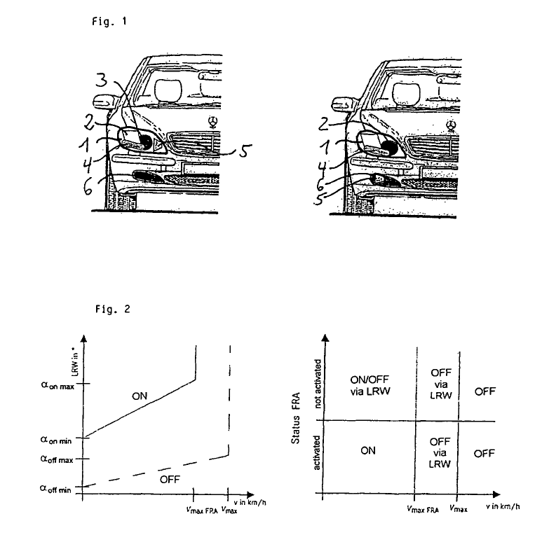

FIG. 2 shows graphs for activating the cornering light and turning light. A switch-on characteristic and a switch-off characteristic of the vehicle are illustrated. The steering lock is illustrated plotted against the speed of the vehicle. The cornering light is not switched on until a maximum speed vₘₐₓ has been dropped below. The additional light is always switched off above this speed vₘₐₓ. With the turn indicator switched on, the switch-on characteristic is lowered by an offset such that the turning light is already switched on given a relatively small steering wheel lock LRW. The system becomes even more sensitive by actuating the turn indicator, because it is necessary to cope with a turning operation. Controlling the switch-on of the cornering light is shown in the right-hand graph. The status of the turn indicator is illustrated in a fashion plotted against the speed V. The status of the turn indicator is activated or deactivated. A distinction is also drawn between the maximum speed of v_{maxFRA} and vₘₐₓ. It is customary in this case to prescribe v_{maxFRA} as 40 km/h, and vₘₐₓ as 70 km/h. The cornering light is activated at a speed below v_{maxFRA} and with an activated turn indicator. The cornering light is switched on and switched off as a function of the steering lock at a speed below v_{maxFRA} and with a deactivated turn indicator. Switching on is performed in accordance with the steering lock at a speed below vₘₐₓ irrespective of the turn indicator. The cornering light is deactivated at a speed above vₘₐₓ irrespective of the status of the turn indicator. With a deactivated turn indicator and below the maximum speed vₘₐₓ, the switching off of the cornering light is controlled via the steering-wheel angle in a fashion similar to the switch-off characteristic in the left-hand graph.

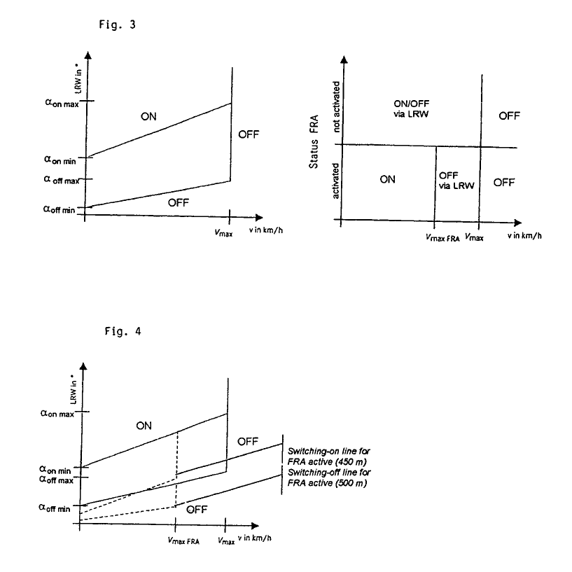

FIG. 3 shows graphs for the activation and deactivation of the additional light in the case of a combination of static cornering light and turning light. The turning light is active below a maximum speed v_{maxFRA}. The turning light is always switched on given an activated turn indicator and below the maximum speed v_{maxFRA}. If, by contrast, the turn indicator is deactivated, the turning light is switched on and off in a fashion similar to the characteristics in the associated left-hand graph, as a function of the steering-wheel angle. However, if the vehicle is moving at below the maximum speed vₘₐₓ, but at above the maximum speed v_{maxFRA}, the static cornering light is switched off in a fashion similar to the switch-off characteristic in the left-hand graph, as a function of the steering-wheel angle. Given a deactivated turn indicator and below the maximum speed vₘₐₓ, the static cornering light is switched on and off in a fashion similar to the switch-on and switch-off characteristic in the associated left-hand graph, as a function of the steering-wheel angle. The static cornering light is always switched off above the maximum speed vₘₐₓ, irrespective of the turn indicator.

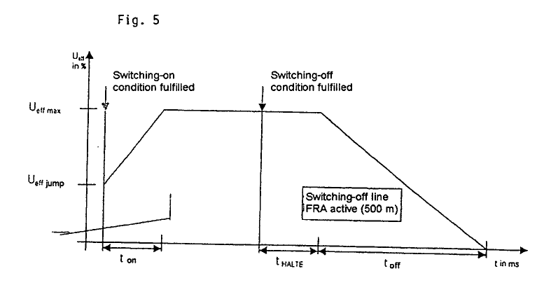

FIG. 4 shows a graph for the activation and deactivation of the static cornering light. The system becomes more sensitive given an activated turn indicator and below v_{maxFRA}. In the case of a static cornering light and below a maximum speed v_{maxFRA} and with an active turn indicator, the switch-on characteristic for the static cornering light is lowered by a specific desired value such that the turning light is already switched on in the case of a small steering lock. Similarly, the switch-off characteristic is lowered by a specific desired value such that the turning light is not switched off until later in the case of a relatively small steering lock. Consequently, with an activated turn indicator the turning light is switched on much earlier and the turning light remains activated longer, since switching off is not performed again until the occurrence of a smaller steering lock.

Below the maximum speed v_{maxFRA} for the set turn indicator, the turn indicator has directional priority over the steering-wheel angle. For example, when the right-hand turn indicator is activated in the case of a steering wheel with left lock in roundabout traffic, the left-hand turning light goes off and the right-hand turning light comes on.

As illustrated in FIG. 5, given fulfillment of the switch-off condition a holding time tₕₐₗₜₑ is prescribed as long as the turning light remains switched on, and so the new turning light is dimmed up in the event of a change in steering direction, while the previously switched-on turning light is further dimmed down. If the lock is now made to the right, the turning light remains active below the switch-off characteristic during the holding time tₕₐₗₜₑ. The switch-on and switch-off characteristics correspond to a constant bend radius over the entire speed range. Understeering the vehicle with rising speed and a constant bend radius results in a rise in the required steering-wheel angle such that the turning light is activated. As guide values, given a constant bend radius the switch-on line is 80 m without actuation of the turn indicator, and 450 m with a turn indicator switched on. The switch-off line without an actuated turn indicator is 250 m. That is where the turning light is switched off. By contrast, the switch-off line is 500 m with a turn indicator that is actuated. The turning light is switched on and off via a ramp function.

The logic is inverted when reverse gear is selected. In this case, the turn indicator is not evaluated. Irrespective of the turn indicator, when reverse gear is selected the turning light is switched on as a function of steering direction such that the left-hand turning light is switched on in the event of right-hand drive, and the right-hand turning light in the event of left-hand drive.

1-6. (canceled)

7. A method for optimizing an additional luminaire forming a turning light, a static cornering light, or both, and having a light distribution with a larger horizontal scattering range than that of a passing light, the light distribution with a larger horizontal scattering range being impressed on a passing light distribution in accordance with a prescribed switch-on characteristic, comprising:
switching the additional luminaire on, in accordance with prescribed switch-on characteristics, so that the additional luminaire functions as a turning light below a first maximum speed,
switching the additional luminaire on so that the additional luminaire functions as a static cornering light below a second maximum speed that is higher than the first maximum speed, and
switching the additional luminaire off in accordance with prescribed switch-off characteristics.

8. The method for optimizing a vehicle light as claimed in claim 7, wherein when the additional luminaire forms a turning light, below the first maximum speed, the switch-on characteristic for the turning light is lowered by a specific desired value via a steering-wheel angle upon actuation of a turn indicator.

9. The method for optimizing a vehicle light as claimed in claim 7, wherein when the additional luminaire forms a turning light, below the first maximum speed, the switch-off characteristic for the turning light is lowered by a specific desired value upon actuation of a turn indicator.

10. The method for optimizing a vehicle light as claimed in claim 8, wherein actuation of the turn indicator has priority over the steering-wheel angle when switching on the turning light.

11. The method for optimizing a vehicle light as claimed in claim 7, wherein the switch-on and switch-off characteristics are not lowered when the additional luminaire forms both a static cornering light and a turning light.

12. The method for optimizing a vehicle light as claimed in claim 8, wherein, upon switching the additional luminaire off, a holding time is prescribed as long as the turning light remains switched on.

13. The method for optimizing a vehicle light as claimed in claim 8, wherein when the additional luminaire forms a turning light, below the first maximum speed, the switch-off characteristic for the turning light is lowered by a specific desired value upon actuation of a turn indicator.

14. The method for optimizing a vehicle light as claimed in claim 9, wherein actuation of the turn indicator has priority over the steering-wheel angle when switching on the turning light.

15. The method for optimizing a vehicle light as claimed in claim 13, wherein actuation of the turn indicator has priority over the steering-wheel angle when switching on the turning light.

16. The method for optimizing a vehicle light as claimed in claim 9, wherein, upon switching the additional luminaire off, a holding time is prescribed as long as the turning light remains switched on.

17. The method for optimizing a vehicle light as claimed in claim 10, wherein, upon switching the additional luminaire off, a holding time is prescribed as long as the turning light remains switched on.

18. The method for optimizing a vehicle light as claimed in claim 13, wherein, upon switching the additional luminaire off, a holding time is prescribed as long as the turning light remains switched on.

19. The method for optimizing a vehicle light as claimed in claim 14, wherein, upon switching the additional luminaire off, a holding time is prescribed as long as the turning light remains switched on.

20. The method for optimizing a vehicle light as claimed in claim 15, wherein, upon switching the additional luminaire off, a holding time is prescribed as long as the turning light remains switched on.
